(19) United States
(12) Patent Application Publication
(10) Pub. No.: US 2015/0159955 A1
(43) Pub. Date: Jun. 11, 2015

(54) REFRACTORY ARTICLE

(71) Applicant: Saint-Gobain Ceramics and Plastics, Inc., Worcester, MA (US)

(72) Inventor: Mark E. Morelock, Bridgeville, PA (US)

(21) Appl. No.: 14/558,704

(22) Filed: Dec. 2, 2014

Related U.S. Application Data
(60) Provisional application No. 61/914,159, filed on Dec. 10, 2013.

(51) Int. Cl. F27D 5/00

(52) U.S. Cl. CPC F27D 5/00

(57) ABSTRACT

A refractory article that can provide a high carrying capacity for generally cylindrical work pieces to be fired while maintaining structural rigidity and integrity. The refractory article can include a body having an opening configured to receive a plurality of substantially cylindrical work pieces and individually support each one of the substantially cylindrical work pieces. In particular embodiments, the present refractory article can include a plurality of discrete containment regions positioned within the opening, each of the discrete containment regions in open communication with adjacent discrete containment regions.

### FIELD OF THE DISCLOSURE

The present disclosure relates to refractory articles, and more particularly, to refractory setter plates.

### RELATED ART

Ceramic processing can be an involved and time consuming task, including sourcing and combining the proper components together into an initial mixture and use of one or more forming processes, such as casting, molding, pressing, spraying, and the like to give the initial mixture shape. The initial shaped body is generally referred to as a green (i.e., unfinished) body. To transform the green body into a ceramic body, generally one or more controlled heating processes can be used to give the body the desired composition and/or microstructure. Typically, such heating processes may use considerably high temperatures, such as on the order of 1,000° C. and higher. Moreover, such heating processes can last for hours or even days.

Refractory articles, such as kiln furniture can be used to properly maintain a green body in a desired position during the heating processes. Refractory articles are heated with green bodies in finite areas, and thus should be suitable for holding the green bodies therein for the duration of the heating process.

The industry continues to demand improvements in kiln furniture.

### BRIEF DESCRIPTION OF THE DRAWINGS

Embodiments are illustrated by way of example and are not limited in the accompanying figures.

FIG. 1 includes a perspective view of a refractory article in accordance with an embodiment.

FIG. 2 includes a side view of a refractory article, as taken along Line B-B of FIG. 3 in accordance with an embodiment.

FIG. 3 includes a top view of a refractory article in accordance with an embodiment.

FIG. 4 includes an enlarged view of a refractory article, as taken from Circle A in FIG. 3, in accordance with an embodiment.

FIG. 5 includes a side view of a refractory article, as taken along Line B-B of FIG. 3 in accordance with an embodiment.

FIG. 6 includes a side view of a refractory article in accordance with an embodiment.

FIG. 7 includes a perspective view of a refractory article in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

As used herein, the term “substantially parallel” refers to objects having a misalignment, or an offsetting angle there between, of less than about 5°, such as less than about 4°, less than about 3°, less than about 2°, or even less than about 1°. For example, an object that is substantially vertical may be offset from a vertical axis by up to about 5°. Use of the terms “substantially” and “approximately” as they relates to other characteristics of the embodiments herein refers to a value falling in a range of plus-or-minus (±) about 10% of the value of that characteristic, such as ±about 8% of the value of that characteristic, ±about 6% of the value of that characteristic, ±about 4% of the value of that characteristic, ±about 3% of the value of that characteristic, ±about 2% of the value of that characteristic, or even ±about 1% of the value of that characteristic.

Unless otherwise defined, all other technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the refractory arts.

The concepts are better understood in view of the embodiments described below that illustrate and do not limit the scope of the present invention. The following description is directed to a refractory article, and particularly, to an article of kiln furniture that provides a high carrying capacity for generally cylindrical work pieces to be fired while maintaining structural rigidity and integrity.

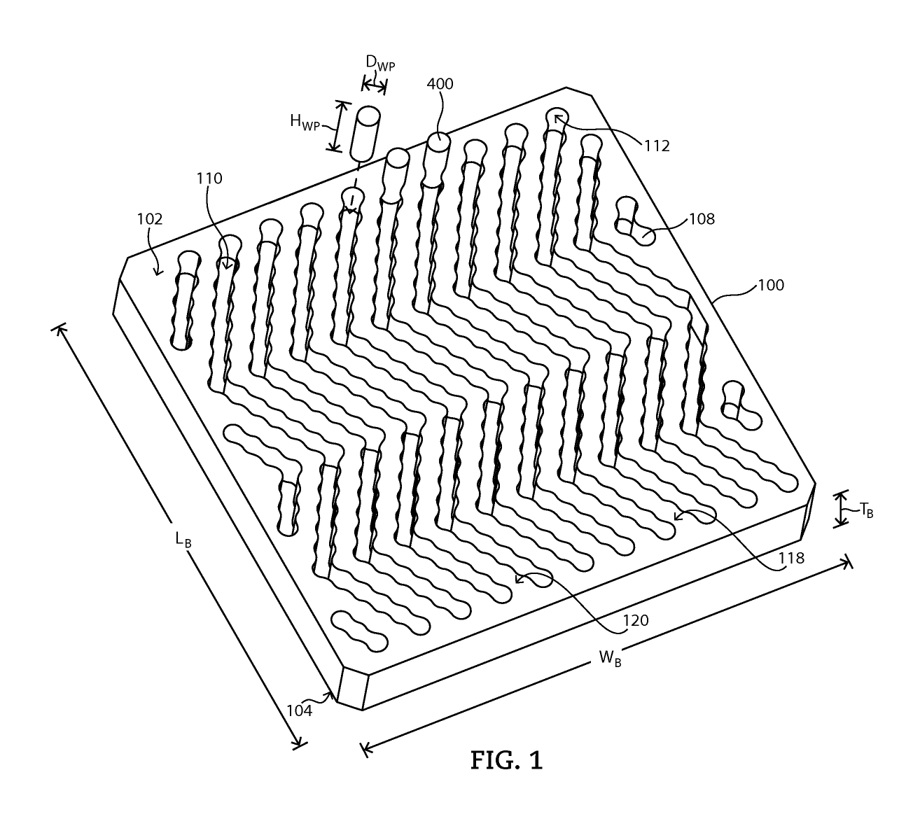

Referring initially to FIG. 1, a refractory setter plate 1 can generally include a body 100 and an opening 108 extending into the body 100. The body 100 can include a plurality of openings 108, such as at least 2 openings, at least 3 openings, at least 4 openings, at least 5 openings, at least 10 openings, at least 15 openings, at least 20 openings, at least 25 openings, at least 30 openings, at least 35 openings, at least 40 openings, at least 45 openings, or even at least 50 openings. In particular embodiments, there can be no greater than 100 openings, such as no greater than 90 openings, no greater than 80 openings, no greater than 70 openings, or even no greater than 60 openings.

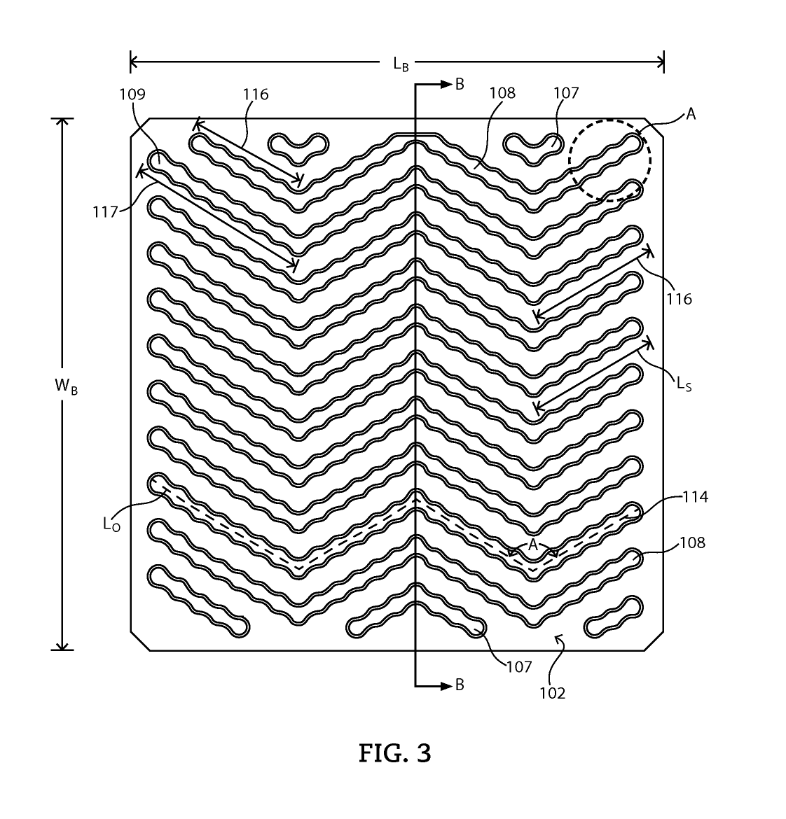

The openings 108 can each extend into the body 100 from a top surface 102 of the body 100. Referring to FIG. 3, in a particular aspect, when viewed from the top surface 102, each one of the openings 108 can be substantially parallel with an adjacent opening 108. In an embodiment, the openings 108 can include a number of segments 116. In a non-limiting embodiment, the openings 108 can all comprise a same number of segments 116. In another embodiment, at least two of the openings 108 can include a different number of segments 116. In a particular aspect, each segment 116 of a first opening 108 can be substantially parallel with an adjacent segment 117 of a second opening 109, the second opening 109 being adjacent to the first opening 108.

In another embodiment, at least two of the openings 108 can have different shapes with respect to one another when viewed perpendicular to the top surface 102. For example, a first opening can comprise a number of segments wherein adjacent segments have a relative angle therebetween, while a second opening can comprise an ellipsoidal shape.

Referring again to FIG. 1, the body 100 can comprise a length, L_{B}, and a width, W_{B}, defining a top surface 102 and a bottom surface 104. Where L_{B} and W_{B} vary, L_{B} represents the maximum length and W_{B} represents a maximum width.

In particular embodiments, the area of the top surface 102 can be equal, or substantially equal, to the area of a bottom surface 104 of the body 100. The top surface 102 can define a surface area, SA_{Ts}. For rectangular bodies 100, SA_{Ts} is equal to L_{B}×W_{B}. Similarly, the bottom surface 104 of the body 100 can also define a surface area, SA_{BS}. For rectangular bodies, SA_{BS} is equal to L_{B}×W_{B}. In particular embodiments, SA_{Ts} can be equal, or substantially equal, to SA_{BS}.

The body 100 can have a thickness, T_{B}. In a particular embodiment, the body 100 can have a substantially uniform thickness, T_{B}. In another embodiment, the thickness, T_{B}, can vary as measured at different locations of the body 100.

In an embodiment, the body 100 can have a generally polygonal configuration when viewed perpendicular to the top or bottom surfaces 102 and 104. For example, the body 100 may have a shape selected from one of the following: a triangle, a quadrilateral, a pentagon, a hexagon, a heptagon, an octagon, a nonagon, a decagon, a hendecagon, a dodecagon.

In a further embodiment, the body 100 may be equilateral. In another embodiment, the body 100 may be equiangular. In a more particular embodiment, the body 100 may define a regular polygon.

In an embodiment, body 100 can be an irregular polygon such that the body 100 is neither equilateral nor equiangular.

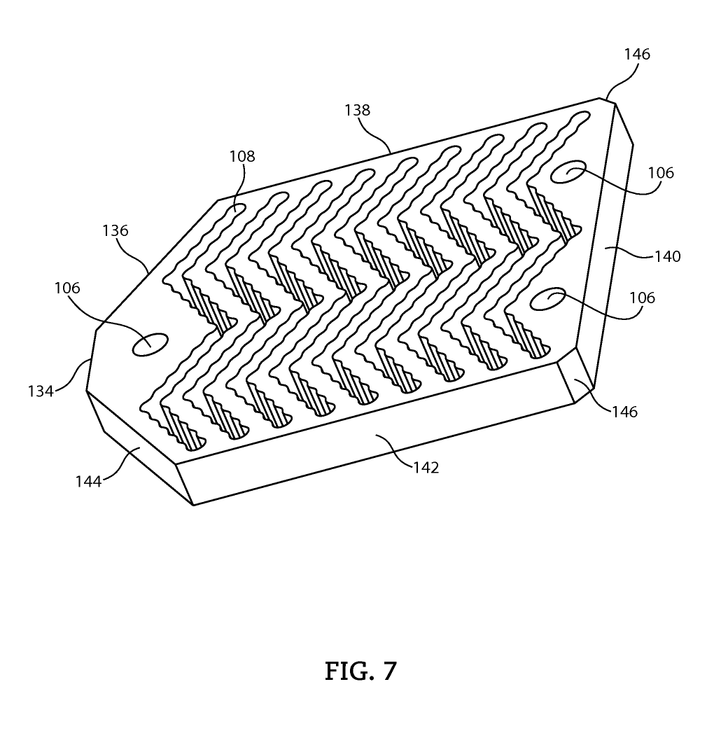

In a particular embodiment, such as illustrated in FIG. 7, the body 100 can have six major side surfaces 134, 136, 138, 140, 142, and 144. At least two of the major side surfaces 134, 136, 138, 140, 142, and 144 can be separated by one or more beveled minor surfaces 146. The beveled minor surfaces 146 may decrease overall weight of the body 100. In an embodiment, beveled minor surfaces 146 may eliminate sharp corners.

As described in greater detail below, body shapes such as illustrated in FIG. 7 may allow all of the openings 108 to have a same carrying capacity, e.g., all of the openings 108 can have the same volume. This may allow for more even weight distribution along the body 100 and facilitate easier insertion of objects into the openings 108.

Referring again to FIG. 1, at least one of the openings 108 can be configured to receive a plurality of substantially cylindrical work pieces 400 each having a height, H_{WP}, a central axis substantially parallel with H_{WP}, and a diameter, D_{WP}. Each of the openings 108 can be configured to receive a plurality of substantially cylindrical work pieces 400 and individually support and maintain each one of the substantially cylindrical work pieces 400 in a constant orientation independent of other substantially cylindrical work pieces 400. As used herein, “individually support” defines a condition whereby the refractory setter plate 1 can maintain orientation of each substantially cylindrical work piece 400 relative to the opening 108 independent of whether additional substantially cylindrical work pieces 400 are present in the same opening 108.

The body 100 can comprise a refractory material, such as, for example, a ceramic material.

In particular embodiments, the body 100 can comprise a carbide, such as silicon carbide. In one particular embodiment, the body 100 can comprise nitrogen-bonded silicon carbide, and more particularly may consist essentially of nitrogen-bonded silicon carbide. Some suitable examples of such materials can include, for example, N-DURANCE® or HEXALOY®.

In other embodiments, the body 100 can comprise materials, such as Alumina, Silica, Zirconia, Spinel, or any combination thereof. These materials can be combined in any relative combination. Moreover, in yet more particular embodiments, the body 100 can further include additional additives.

In particular embodiments, the body 100 can comprise a material having a porosity of no greater than about 60 vol % for a total volume of the body. In yet other instances, the body 100 can have a porosity of no greater than about 10 vol %, such as no greater than about 5 vol %, no greater than about 4 vol %, no greater than about 3 vol %, no greater than about 2 vol %, no greater than about 1 vol %, no greater than about 0.5 vol %, or even no greater than about 0.1 vol %. Moreover, in a particular embodiment, the body 100 can comprise a material having essentially no porosity.

In further embodiments, the body 100 can comprise a material having a Modulus of Elasticity (MOE) at 20° C. of no less than about 5 gigapascals (GPa), as measured according to ASTM C885-87. In still another embodiment, the body 100 can comprise a material having a MOE of no less than about 20 GPa, no less than about 50 GPa, no less than about 75 GPa, no less than about 90 GPa, no less than about 100 GPa, no less than about 110 GPa, no less than about 120 GPa, no less than about 130 GPa, no less than about 140 GPa, no less than about 150 GPa, no less than about 175 GPa, no less than about 200 GPa, no less than about 250 GPa, no less than about 300 GPa, or even no less than about 350 GPa. In another embodiment, the body 100 can comprise a material having a Modulus of Elasticity at 20° C. of no greater than about 500 GPa, such as no greater than about 450 GPa, or even no greater than about 400 GPa. Moreover, the body 100 can comprise a material having a Modulus of Elasticity at 20° C. within in a range between and including any of the values described above, such as, for example, between about 150 GPa and about 300 GPa.

In yet further embodiments, the body 100 can comprise a material having a Modulus of Rupture (MOR) at 1250° C. of no less than about 1.5 megapascals (MPa), as measured according to ASTM C133. In still another embodiment, the body 100 can comprise a material having a MOR of no less than about 10 MPa, no less than about 25 MPa, no less than about 50 MPa, no less than about 75 MPa, no less than about 100 MPa, no less than about 150 MPa, no less than about 200 MPa, no less than about 250 MPa, no less than about 300 MPa, or even no less than about 350 MPa. In such embodiments, the body 100 can comprise a material having a Modulus of Rupture at 1250° C. of no greater than about 500 MPa, such as no greater than about 450 MPa, or even no greater than about 400 MPa. Moreover, the body 100 can comprise a material having a Modulus of Rupture at 1250C within a range between and including any of the values described above, such as, for example, between about 90 MPa and about 320 MPa.

In certain embodiments, the body 100 can comprise a material having a coefficient of thermal expansion (CTE) of no greater than about 9.0×10⁻⁶ mm/mm·° C.⁻¹, as measured according to ASTM C832. In still another embodiment, the body 100 can comprise a material having a CTE of no greater than about 8.5×10⁻⁶ mm/mm·° C.⁻¹, no greater than about 8.0×10⁻⁶ mm/mm.° C.⁻¹, no greater than about 7.5×10⁻⁶ mm/mm·° C.⁻¹, no greater than about 7.0×10⁻⁶ mm/mm·° C.⁻¹, no greater than about 6.5×10⁻⁶ mm/mm·° C.⁻¹, no greater than about 6.0×10⁻⁶ mm/mm·° C.⁻¹, no greater than about 5.5×10⁻⁶ mm/mm·° C.⁻¹, no greater than about 5.0×10⁻⁶ mm/mm·° C.⁻¹, or even no greater than about 4.5×10⁻⁶ mm/mm·° C.⁻¹. In such embodiments, the body 100 can comprise a material having a CTE of no less than about 1.0×10⁻⁶ mm/mm·° C.⁻¹, such as no less than about 2.0×10⁻⁶ mm/mm·° C.⁻¹, no less than about 3.0×10⁻⁶ mm/mm·° C.⁻¹, no less than about 3.5×10⁻⁶ mm/mm·° C.⁻¹, or even no less than about 4.0×10⁻⁶ mm/mm·° C.⁻¹. Moreover, the body 100 can comprise a material having a CTE within a range between and including any of the values described above, such as, for example, between about 4.0×10⁻⁶ mm/mm·° C.⁻¹ and about 4.8×10⁻⁶ mm/mm·° C.⁻¹.

In particular embodiments, the body 100 can comprise a material having a thermal conductivity at 1200° C. of no less than about 0.5 W/mK, as measured according to ASTM C1113, such as no less than about 5 W/mK, no less than about 10 W/mK, no less than about 15 W/mK, no less than about 20 W/mK, no less than about 25 W/mK, no less than about 30 W/mK, or even no less than about 40 W/mK. In such embodiments, the body 100 can comprise a material having a thermal conductivity at 1200° C. of no greater than about 100 W/mK, such as no greater than about 90 W/mK, no greater than about 80 W/mK, no greater than about 70 W/mK, no greater than about 60 W/mK, or even no greater than about 50 W/mK. Moreover, the body 100 can comprise a material having a thermal conductivity at 1200C within a range between and including any of the values described above, such as, for example, between about 30 W/mK and about 41 W/mK.

In yet other embodiments, the body 100 can comprise a material having a maximum usable temperature, as defined by the maximum operating temperature (i.e., the body will not melt and remains operable), of no less than about 1100° C., such as no less than about 1200° C., no less than about 1300° C., no less than about 1400° C., no less than about 1500° C., no less than about 1600° C., no less than about 1700° C., no less than about 1800° C., no less than about 1900° C., no less than about 2000° C., no less than about 2100° C., no less than about 2200° C., no less than about 2300° C., or even no less than about 2400° C. Moreover, the body 100 can comprise a material having a maximum usable temperature within a range between and including any of the values described above, such as, for example, between about 1750° C. and about 1890° C.

It should be understood that the body 100 can be formed from a material having any one or more of the material properties described above. It should be understood that the body 100 can be formed from a material having any of the above described characteristics and that the composition thereof is not intended to be limited by this description.

In particular embodiments, the body 100 can be formed from a monolithic, single-piece construction. The body 100 can be formed, for example, by shaping, firing, molding, extruding, pressing (e.g., mechanical pressing, hydraulic pressing, vibration pressing, etc.), stamping, rolling, extruding, drying, or any combination thereof.

In certain embodiments, the body 100 can additionally be surface treated or surface finished.

Moreover, in one non-limiting embodiment, although not applicable to all embodiments, the body 100 may not include a polymer, and more particularly, may be essentially free of any/all polymers. In a particular aspect, the body 100 can comprise a single material free of any coating or surface layer.

The body 100 can be untreated or treated to enhance the physical and/or chemical properties thereof. In particular embodiments, the body 100 can be treated using techniques, such as, for example, laser melting or ablation, mechanical sandblasting and/or chemical picking. In further embodiments, the body 100 can be treated by galvanizing, chromate or phosphate treatments, and/or anodizing.

In other embodiments, the body 100 can be formed from multiple components connected together. The multiple components may be engaged to form the body 100 by any method recognizable in the art, such as, for example, by melting, sintering, welding, threaded/nonthreaded engagement, or any combination thereof.

The body 100 can comprise a homogeneous composition or may comprise two or more discrete portions having different compositions.

Referring to FIG. 1, each one of the openings 108 can extend into the body from the top surface 102. In particular embodiments, the openings 108 can extend into the body 100 substantially perpendicular to the top surface 102. In alternative embodiments, the openings 108 can extend into the body 100 in a direction non-perpendicular to the top surface 102. In this regard, the openings 108 can be angularly offset from perpendicular with the top surface 102.

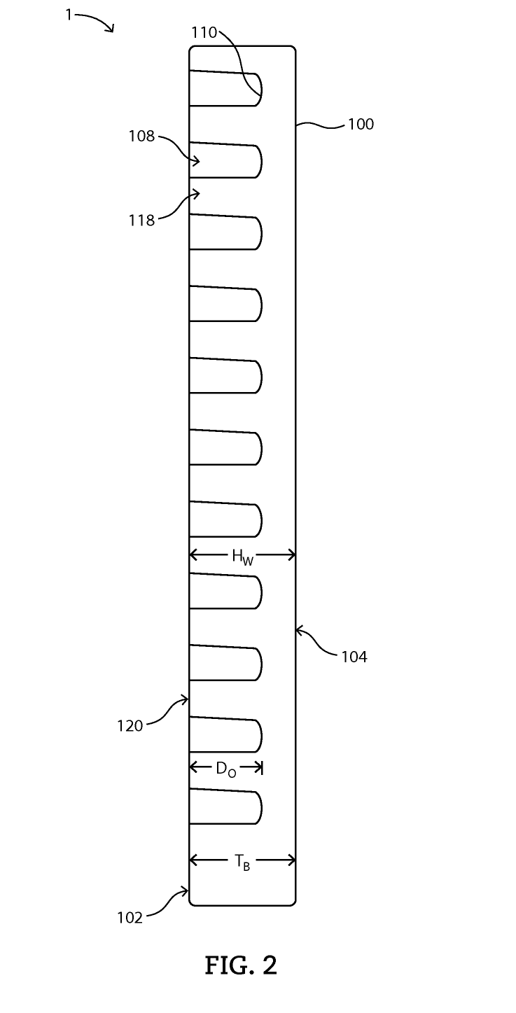

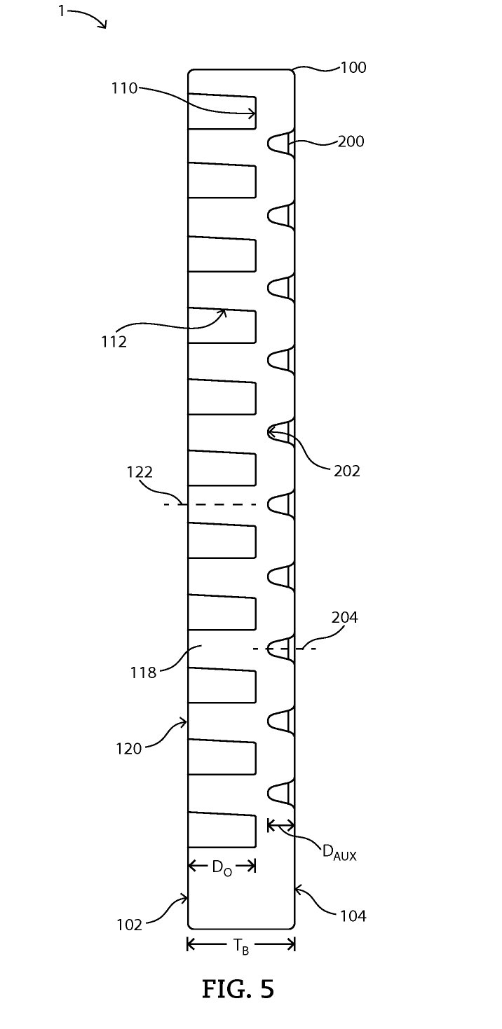

In particular embodiments, the openings 108 can each comprise a bottom surface 110. The bottom surface 110 of the openings 108 can comprise any shape. For example, as shown in FIG. 5, in particular embodiments, the bottom surface 110 of the openings 108 can be flat and parallel with the top surface 102 of the body 100. In other embodiments, like as shown in FIG. 2, the bottom surface 110 of the openings 108 can be hemispherical (i.e., outwardly rounded). In such embodiments, the bottom surface 110 of the openings 108 can comprise a point location as measured by a maximum distance the opening 108 extends from the top surface 102 of the body 100. In yet other embodiments, the bottom surface 110 of the openings 108 can comprise any shape, such as, for example, a polygonal or ellipsoidal shape positioned at any angle relative to the top surface 102 of the body 100.

As illustrated in FIG. 2, the openings 108 can extend into the body 100 a distance, D_{O}, as measured by a maximum distance from the top surface 102 of the body 100 to the bottom surface 110 of each one of the openings 108. In particular embodiments, T_{B} can be greater than D_{O}. In more particular embodiments, T_{B}/D_{O} can be at least about 1.01, such as at least about 1.05, at least about 1.10, at least about 1.15, at least about 1.20, at least about 1.25, at least about 1.30, at least about 1.35, at least about 1.40, at least about 1.45, at least about 1.50, at least about 1.55, at least about 1.60, at least about 1.65, at least about 1.70, at least about 1.75, at least about 1.80, at least about 1.85, at least about 1.90, at least about 1.95, or even at least about 2.00. In such aspect, T_{B}/D_{O} can be no greater than about 5.0, such as no greater than about 4.0, no greater than about 3.0, or even no greater than about 2.0. Moreover, T_{B}/D_{O} can be within a range between and including any of the values described above, such as, for example, between about 1.3 and about 2.1.

In other embodiments, T_{B} can be approximately equal to D_{O}. In such a manner, the opening 108 can extend at least partially or entirely through the body 100.

Referring now to FIG. 3, each one of the openings 108 can have a length, L_{O}, extending along the length of the body, L_{B}. In particular embodiments, the length of the opening 108 can be measured along a centerline 114 of each one of the openings 108. In a particular embodiment, L_{B}/L_{O} can be no less than about 0.3, such as no less than about 0.4, no less than about 0.5, no less than about 0.6, no less than about 0.7, no less than about 0.8, no less than about 0.9, no less than about 1.0, no less than about 1.2, or even no less than about 1.4. In particular aspects, L_{B}/L_{O} can be no greater than about 10.0, such as no greater than about 5.0, no greater than about 2.0, or even no greater than about 1.5. Moreover, L_{B}/L_{O} can be within a range of between and including any of the values described above, such as, for example, between about 0.9 and about 1.4.

In particular embodiments, the body 100 can include a plurality of perimeter openings 107. The perimeter openings 107 may be broken (i.e., they are not continuous) and/or may be shorter in length than the openings 108. In a particular embodiment, the perimeter openings 107 can comprise a non-fully formed opening 108.

In a particular aspect, each one of the openings 108 can extend along the length of the body, L_{B}, in a substantially straight line when viewed from the top surface 102 of the body 100. In such embodiments, the length of the openings, L_{O}, is measured by the largest dimension thereof.

In other embodiments, each one of the openings 108 can extend along the length of the body, L_{B}, in a non-linear orientation when viewed from the top surface 102 of the body 100. In such a manner, the openings 108 can form a generally ellipsoidal or polygonal shape when viewed from the top surface 102 of the body 100. In such embodiments, the length of the openings, L_{O}, is measured by the largest dimension as measured along the centerline 114 of the openings 108.

In certain embodiments, as seen in FIG. 3, each one of the openings 108 can form a substantially serrated shape when viewed from the top surface 102 of the body 100. In such embodiments, each one of the openings 108 can comprise a plurality of segments 116. Each segment 116 can have a length, L_{S}, as measured along the centerline 114 of the opening 108. In particular embodiments, the length of each segment 116 may have a particular length relative to the length of the corresponding opening 108 expressed as L_{O}/L_{S}. In one embodiment, L_{O}/L_{S} can be no less than about 2, such as no less than about 3, no less than about 4, no less than about 5, no less than about 6, no less than about 7, no less than about 8, no less than about 9, or even no less than about 10. In further embodiments, L_{O}/L_{S} can be no greater than about 100, such as no greater than about 75, no greater than about 50, or even no grater than about 25. L_{O}/L_{S} can also be within a range between and including any of the values described above, such as, for example, between about 6 and about 10.

In other words, in particular embodiments each one of the openings 108 can comprise at least 2 segments, such at least 3 segments, at least 4 segments, at least 5 segments, at least 6 segments, at least 7 segments, at least 8 segments, at least 9 segments, or even at least 10 segments. In particular embodiments, each one of the openings 108 can comprise no more than 200 segments, such as no more than 100 segments, no more than 75 segments, no more than 50 segments, or even no more than 25 segments. Moreover, each one of the openings 108 can comprise a number of segments 116 within a range between and including any of the values described above, such as, for example, between 6 and 10 segments.

In particular embodiments, two adjacent segments 116, when viewed from the top surface 102 of the body 100 can form a relative angle, A, therebetween. In particular embodiments, the relative angle, A, can be less than about 180 degrees, such as less than about 170 degrees, less than about 160 degrees, less than about 150 degrees, less than about 140 degrees, less than about 130 degrees, less than about 120 degrees, less than about 110 degrees, less than about 100 degrees, less than about 90 degrees, less than about 80 degrees, less than about 70 degrees, less than about 60 degrees, less than about 50 degrees, less than about 40 degrees, less than about 30 degrees, less than about 20 degrees, or even less than about 10 degrees. In more particular embodiments, the relative angle, A can be greater than about 1 degree, greater than about 2 degrees, greater than about 3 degrees, greater than about 4 degrees, greater than about 5 degrees, greater than about 6 degrees, greater than about 7 degrees, greater than about 8 degrees, greater than about 9 degrees. Moreover, the relative angle, A, between segments, can be within a range between and including any of the values described above, such as, for example, between about 45 degrees and about 70 degrees.

In a non-limiting embodiment, each one of the openings 108 can comprise a plurality of segments 116 wherein the relative angle, A, between adjacent segments 116 varies segment-by-segment (e.g., angle, A, formed between two adjacent segments is 60° whereas the angle, A, formed between two other adjacent segments is 90°). Thus, in a certain embodiment, the segments 116 can combine to form any number of shapes along the body 100 when viewed from the top surface 102. For example, the segments 116 can combine to form a triangular shape, a rectangular shape, a pentagonal shape, a curved shape, or any combination thereof.

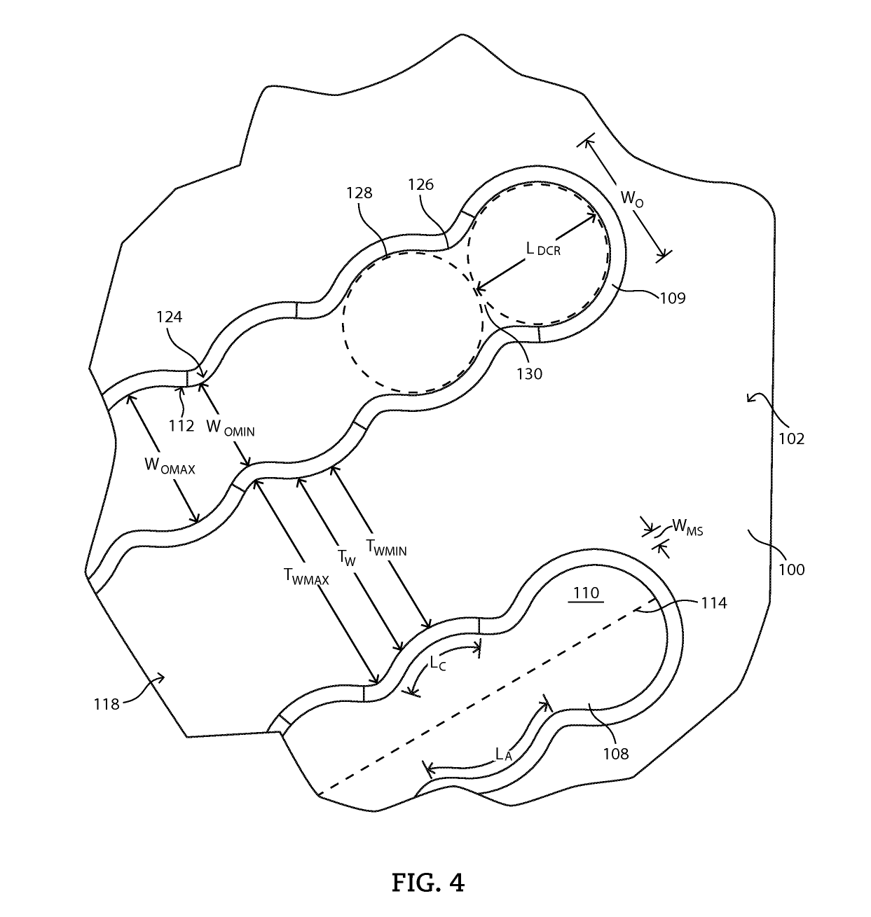

Referring now to FIG. 4, to define an internal storage volume, the opening 108 can further comprise an average width, W_{O}, a minimum width, W_{OMIN}, and a maximum width, W_{OMAX}, as measured perpendicular to the centerline 114 of the opening 108. In a particular aspect, the length of the opening, L_{O}, can be greater than the width of the opening, W_{O}. In particular embodiments, L_{O}/W_{O} can be greater than about 1.5, such as greater than about 2.0, greater than about 2.5, greater than about 3.0, greater than about 3.5, greater than about 4.0, greater than about 4.5, greater than about 5.0, greater than about 10.0, greater than about 15.0, greater than about 20.0, greater than about 25.0, greater than about 30.0, greater than about 35.0, greater than about 40.0, greater than about 45.0, or even greater than about 50.0. In more particular embodiments, L_{O}/W_{O} can be no greater than about 200, such as no greater than about 175, no greater than about 150, no greater than about 125, no greater than about 100, or even no greater than about 75. Moreover, in certain embodiments L_{O}/W_{O} can be within a range between and including any of the values described above, such as, for example, between about 25 and about 40.

In particular embodiments, W_{B}/W_{O} can be no less than about 1.0, such as no less than about 2.0, no less than about 5.0, no less than about 10.0, no less than about 20.0, no less than about 30.0, or even no less than about 40.0. In such embodiments, W_{B}/W_{O} can be no greater than about 100, such as no greater than about 90, no greater than about 80, no greater than about 70, no greater than about 60, no greater than about 50, or even no greater than about 40. Moreover, in particular embodiments, W_{B}/W_{O} can be within a range between and including any of the values described above, such as, for example, between about 30 and about 60.

In one embodiment, an open volume, V_{O}, of each opening 108 can be defined by the volume contained within each one of the openings 108 below the top surface 102 of the body 100. Similarly, the body 100 can define a total volume, V_{B}, as measured in a three-dimensional space by W_{B}×L_{B}×T_{B} as the solid (non-void) volume of material making up the body. In particular embodiments, V_{B}/V_{O} can be no less than about 1.5, such as no less than about 2.0, or even no less than about 2.5. Furthermore, V_{B}/V_{O} can be no greater than about 75, such as no greater than about 50, no greater than about 30, no greater than about 10, no greater than about 5, no greater than about 4, or even no greater than about 3. Moreover, V_{B}/V_{O} can be within a range between and including any of the values described above, such as, for example, between about 6.0 and about 9.0.

Each one of the openings 108 can be configured to receive a plurality of substantially cylindrical work pieces. In particular embodiments, each one of the openings 108 can be configured to receive no less than two substantially cylindrical work pieces. In yet further embodiments, the opening 108 can be configured to receive no greater than 1000 substantially cylindrical work pieces, such as no greater than 500 substantially cylindrical work pieces, no greater than 400 substantially cylindrical work pieces, no greater than 300 substantially cylindrical work pieces, no greater than 200 substantially cylindrical work pieces, or even no greater than 100 substantially cylindrical work pieces. Moreover, the opening 108 can be configured to receive any number of substantially cylindrical work pieces in a range between and including any of the values described above, such as, for example, between about 40 and about 120.

Referring again to FIG. 2, which includes a side view of the refractory setter plate 1, a wall 118 can be positioned between adjacent openings 108. In certain embodiments, each wall 118 can extend from a plane parallel with the bottom surface 110 of the openings 108 towards a plane formed by the top surface 102 of the body 100.

In a particular aspect, a top surface 120 of each wall can be substantially coplanar with the top surface 102 of the body 100. In another aspect, the top surface 120 of each wall 118 can form a plane that is not coplanar with the top surface 102 of the body 100. Accordingly, in particular embodiments the height of the wall, H_{W}, as measured perpendicular to the top surface 102 of the body 100, can be less than the depth of the opening, D_{O}.

Referring again to FIG. 4, each wall 118 can comprise an average wall thickness, T_{W}, a maximum wall thickness, T_{WmAX}, and a minimum wall thickness, T_{WmiN}, as measured by an average distance each one of the walls 118 extends between adjacent openings 108, perpendicular to the centerline of each opening 108. In particular embodiments, the average wall thickness, T_{W}, can be less than the maximum width of the openings, W_{OMAX}. For example, T_{W}/W_{OMAX} can be at least about 0.5, such as at least about 0.6, at least about 0.7, at least about 0.8, at least about 0.9, or even at least about 1.0. In further embodiments, T_{W}/W_{OMAX} can be no greater than about 4.0, such as no greater than about 3.0, no greater than about 2.0, or even no greater than about 1.5. Moreover, T_{W}/W_{OMAX} can be within a range between and including any of the values described above, such as, for example, between about 0.75 and about 0.80.

In particular embodiments, to prevent failure over prolonged uses, the minimum thickness, T_{WMIN}, of the walls 118 can be no less than about 0.25 inches.

In a particular aspect, the maximum wall thickness, T_{WMAX}, can be equal to the maximum width of the opening, W_{OMAX}.

Moreover, in a further aspect, the minimum wall thickness, T_{WMIN}, can be equal to the minimum width of the opening, W_{OMIN}.

In certain embodiments, W_{OMAX} T_{WMIN} can be equal, or substantially equal, to W_{OMIN}+T_{WMAX}. In further embodiments, T_{W} can be equal, or substantially equal, to W_{O}.

Moreover, in particular embodiments, T_{WMAX} can be equal to T_{WMIN} and can also be equal to T_{W}. Furthermore, in particular embodiments, \V_{OMAX} can be equal to W_{OMIN} and can also be equal to W_{O}.

In certain embodiments, each opening 108 can include a beveled edge 109 connecting the top surface 102 of the body 100 with the sidewall 112 of the opening 108.

In particular embodiments, each opening 108 can further include a structure 124 configured to individually support a substantially cylindrical work piece within the opening 108 and maintain the substantially cylindrical work piece in a constant orientation therein. In such a manner, each opening 108 can simultaneously receive a plurality of substantially cylindrical work pieces while individually supporting each of the plurality of substantially cylindrical work pieces.

In a particular aspect, each opening 108 can comprise a plurality of structures 124. The plurality of structures 124 can be equally spaced apart within each one of the openings 108 when viewed from the top surface 102 of the body 100.

In certain embodiments, the structures 124 can comprise at least one projection 126. The projection 126 can extend from a surface of the body 100 into the cavity defined by the opening 108. More particularly, the projection 126 can extend from a sidewall 112 of the opening 108 into the opening 108.

In an alternative embodiment (not shown), each projection 126 can extend from the bottom surface 110 of the opening 108 in a direction generally parallel with the sidewall 112 toward a plane formed by the top surface 102 of the body 100.

The projections 126 can comprise, for example, a rod, a notch, a bracket, a tine, a corrugation, or any combination thereof. Each projection 126 can be integral with the body 100 (i.e., monolithic) or attached to the body 100 as a separate component.

In a particular embodiment, the structure 124 can extend from the sidewall 112 and can have a generally polygonal cross sectional profile when viewed from the top surface 102 of the body 100. In a further embodiment, the structure 124 can extend from the sidewall 112 and can have a generally triangular cross sectional profile when viewed from the top surface 102 of the body 100. In an alternative embodiment, the structure 124 can extend from the sidewall 112 and can have a generally ellipsoidal cross sectional profile when viewed from the top surface 102 of the body 100. In yet a further embodiment, the structure 124 can extend from the sidewall 112 and can have any combination of the above cross sectional profiles.

In a particular aspect, the structure can have a maximum width, W_{MS}, as measured by a maximum distance the structure extends from the sidewall of the opening into the cavity defined by the opening when viewed from the top surface 102 of the body 100. In particular embodiments, W_{MS} can be no less than about 0.01 W_{OMAX}, such as no less than about 0.05 W_{OMAX}, no less than about 0.10 W_{OMAX}, no less than about 0.15 W_{OMAX}, no less than about 0.20 W_{OMAX}, no less than about 0.25 W_{OMAX}, no less than about 0.30 W_{OMAX}, no less than about 0.35 W_{OMAX}, no less than about 0.40 W_{OMAX}, no less than about 0.45 W_{OMAX}, or even no less than about 0.50 W_{OMAX}. Furthermore, W_{MS} can be less than about 1.0 W_{OMAX}, such as less than about 0.95 W_{OMAX}, less than about 0.90 W_{OMAX}, less than about 0.85 W_{OMAX}, less than about 0.80 W_{OMAX}, less than about 0.75 W_{OMAX}, less than about 0.70 W_{OMAX}, less than about 0.65 W_{OMAx}, less than about 0.60 W_{OMAX}, less than about 0.55 W_{OMAX}, less than about 0.50 W_{OMAX}, or even less than about 0.45 W_{OMAX}. Moreover, W_{MS} can be within a range between and including any of the values described above, such as, for example, between about 0.20 W_{OMAX} and about 0.30 W_{OMAX}.

In a particular aspect, the structure 124 can extend into each one of the openings 108 and contact the bottom surface 110 thereof. In another embodiment, the structure 124 can extend into each one of the openings 108 a distance that does not contact the bottom surface 110.

The plurality of structures 124 can define a plurality of discrete containment regions 128 within each opening 108. Each discrete containment region 128 can be adapted to support a discrete work piece.

In a particular embodiment, each opening 108 can comprise at least 2 discrete containment regions, such as at least 5 discrete containment regions, at least 10 discrete containment regions, at least 15 discrete containment regions, at least 20 discrete containment regions, at least 30 discrete containment regions, at least 40 discrete containment regions, at least 50 discrete containment regions, at least 75 discrete containment regions, at least 100 discrete containment regions, at least 150 discrete containment regions, or even at least 200 discrete containment regions. In such embodiments, each opening can comprise no more than 500 discrete containment regions, such as no more than 400 discrete containment regions, no more than 300 discrete containment regions, or even no more than 200 discrete containment regions. Moreover, each opening can comprise a number of discrete containment regions within a range between and including any of the values described above, such as, for example, about 35 and about 45.

In a particular embodiment, each one of the openings 108 can have the same number of discrete containment regions 128 as the other openings 108. In an alternate embodiment, each one of the openings 108 can comprise a number of containment regions, N_{DCR}, wherein N_{DCR} is not the same for each opening 108.

To enhance the number of substantially cylindrical work pieces that can fit in the refractory article 1, each discrete containment region 128 can be at least partially in open communication with an adjacent discrete containment region 128 located in the same opening 108. In a particular example, each non-terminal discrete containment region 128 (i.e., those discrete containment regions 128 not at the end of the openings 108) can comprise four structures 124, two structures on a first side of the opening 108 and two structures on a second side of the opening 108, opposite the first side of the opening 108. In a further embodiment, adjacent discrete containment regions 128 can share a pair of opposing structures 124. A gap 130 can extend between the structures, generally perpendicular to the centerline 114 of the opening 108 when viewed from the top surface 102 of the body 100. Thus, two adjacent discrete containment regions 128 can be openly connected by the gap 130 (i.e., there is open communication therebetween).

In particular embodiments, the plurality of structures 124 can be arranged within the opening 108 to define an undulated sidewall profile of the opening 108, as seen in FIG. 4. The undulated sidewall profile can then define a plurality of discrete containment regions between adjacent undulations.

Each discrete containment region 128 not positioned on an end of the opening 108 can define a discrete containment region arc length, L_{A}, as measured by the arc length of the sidewall 112 of the opening 108 between adjacent gaps 130. The arc length, L_{A}, of each discrete containment region can be no less than a contact length, L_{C}, as measured by the length in which one of the plurality of substantially cylindrical work pieces contacts the arc length, L_{A}. In a particular embodiment, L_{A}/L_{C} can be no less than about 1.0, such as no less than about 1.1, no less than about 1.2, no less than about 1.3, no less than about 1.4, no less than about 1.5, or even no less than about 1.6. In certain embodiments, L_{A}/L_{C} can be no greater than about 2.5, such as no greater than about 2.0, no greater than about 1.9, no greater than about 1.8, no greater than about 1.7, or even no greater than about 1.6. Moreover, L_{A}/L_{C} can be within a range between and including any of the values described above, such as, for example, between about 1.05 and about 1.25.

In particular embodiments, the arc length, L_{A}, can be within a range between and including about 0.1 inches and about 12.0 inches. In a more particular embodiment, the arc length, L_{A}, can be within a range between and including about 0.25 inches and about 1.0 inch. In yet more particular embodiments, the arc length, L_{A}, can be within a range between and including 0.4 inches and about 0.6 inches.

In particular embodiments, each one of the discrete containment regions can define a length, L_{DCR}, as measured between opposing gaps 130 along the centerline 114. L_{A}/L_{DCR} can be within a range between about 1.0 and about 3.0, such as between about 1.01 and about 2.5, between about 1.05 and about 2.0, between about 1.05 and about 1.5, between about 1.05 and about 1.4, or even between about 1.1 and about 1.3.

In other embodiments, L_{A}/L_{DCR} can be within a range between about 1.25 and about 4.0, such as within a range of between about 1.25 and about 2.0, between about 1.25 and about 1.5, or even between about 1.30 and about 1.40.

The refractory article 1 can have a carrying capacity, as measured by the number of substantially cylindrical work pieces that the refractory article 1 can receive per a given area as seen from the top surface of the body 100. Generally, the carrying capacity can be established using the following equation of discrete conformal mapping:

$${N}_{WP} = \frac{Unit Area - Wall Area}{{A}_{WP}} ( Circle Packing Efficiency )$$

Wherein N_{WP} is a number of substantially cylindrical work pieces (or carrying capacity per given area); unit area is a pre-selected unit area (e.g., 1 square inch, 2 square inches, or even the entire area of the top surface 102 of the body 100); wall area is the area of the wall 118 within the given unit area as viewed from the top surface of the body; A_{WP} is the cross-sectional area of one of the substantially cylindrical work pieces; and circle packing efficiency is a unit-less value describing the efficiency of packing as determined by the relative number of circles (cross-sectional shape of cylindrical objects as viewed along a central axis) that can be fit into a given area such that no two circles overlap and at least some of the circles are mutually tangent with each other.

A circle packing efficiency of 1.0 describes a packing arrangement that is fully optimized (e.g., 100% efficiency) where no space is left unoccupied by the circles (i.e., no gaps between adjacent circles). A circle packing efficiency of 0.80 describes a packing arrangement where 80% of the cross-sectional area is occupied by the circle and 20% of the area is unoccupied.

Generally, the circle packing efficiency of a Euclidean area can be defined by the packing arrangement. No known packing arrangement of circles can result in a packing efficiency of 1.0. A hexagonal packing arrangement (e.g., a {6,6,6} tessellation), in which the centers of the circles are arranged in a hexagonal lattice (or staggered rows) has a packing efficiency of approximately 0.9069. On the other hand, for example, a square packing arrangement (with a {4,4,4,4} tessellation) has a packing efficiency of approximately 0.7854.

In particular embodiments, the refractory article 1 as contemplated herein can have openings 108 arranged such that the discrete containment regions 128 of the openings 108 have a generally hexagonal lattice arrangement.

In a non-limiting embodiment, the refractory article 1 can have a carrying capacity of at least about 1.0 substantially cylindrical work pieces per square inch when viewed from the top surface 102 of the body 100, wherein each one of the plurality of substantially cylindrical work pieces has a cross sectional area, A_{WP}, and wherein A_{WP} is approximately 0.283 square inches. For example, in particular embodiments, the refractory article 1 can have a carrying capacity of at least about 1.1 substantially cylindrical work pieces per square inch when A_{WP} is approximately 0.283 square inches, such as at least about 1.2 substantially cylindrical work pieces per square inch, at least about 1.3 substantially cylindrical work pieces per square inch, at least about 1.4 substantially cylindrical work pieces per square inch, at least about 1.5 substantially cylindrical work pieces per square inch, or even at least about 1.6 substantially cylindrical work pieces per square inch. In more particular embodiments, the refractory article 1 can have a carrying capacity of no greater than about 4 substantially cylindrical work pieces per square inch when A_{WP} is approximately 0.283 square inches, no greater than about 3 substantially cylindrical work pieces per square inch, or no greater than about 2 substantially cylindrical work pieces per square inch.

Conversely, previously known refractory articles devoid of the features of the herein described refractory article 1, can either (i) hold no more than 1 substantially cylindrical work piece (having a cross sectional area of approximately 0.283 in²) per square inch, or (ii) are incapable of individually supporting each work piece. Thus, embodiments of the present invention are capable of increasing the carrying capacity of a refractory article by more than 60% while simultaneously maintaining individual support of each work piece.

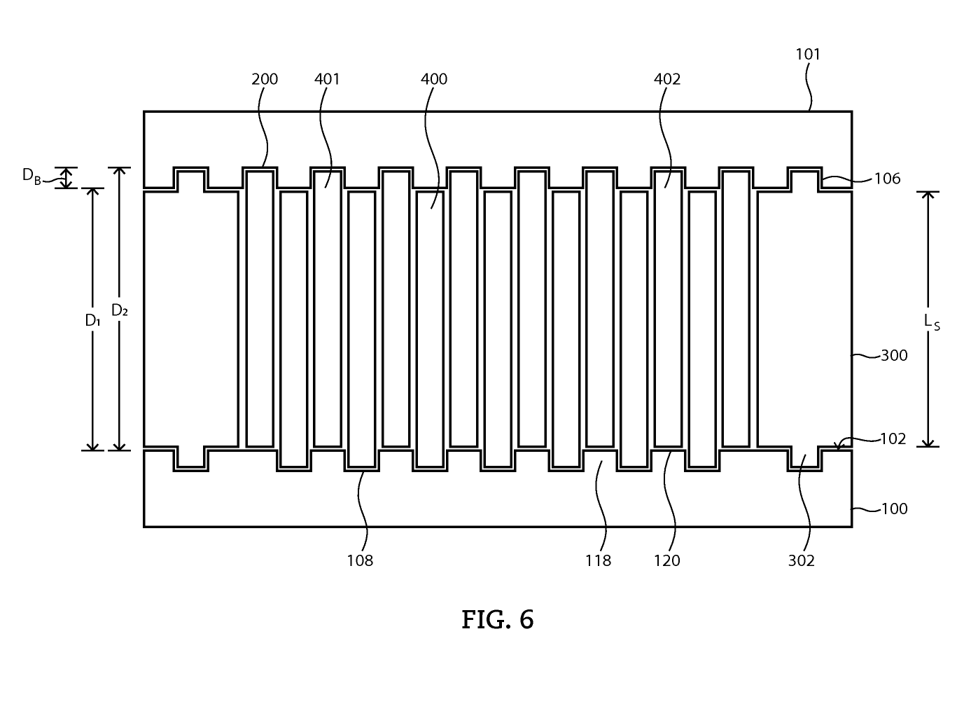

Referring to FIGS. 5 and 6, in particular embodiments, the refractory article 1 can be configured to receive a second plurality of substantially cylindrical work pieces 401. The refractory article 1 can be configured to receive the second plurality of substantially cylindrical work pieces 401 along the top surface 120 of the wall 118.

In particular embodiments, the second plurality of substantially cylindrical work pieces 401 can have the same dimensional characteristics (e.g., length, diameter, aspect ratios, cross sectional profiles) as the plurality of substantially cylindrical work pieces 400. In such a manner, when positioned on the top surface 120 of the wall 118, the second plurality of substantially cylindrical work pieces 401 can extend a distance, D₂, above, and perpendicular to, the top surface 102 of the body 100. Distance, D₂, can be greater than the distance that each one of the plurality of substantially cylindrical work pieces 400 extends beyond the top surface 102 of the body 100, by a distance D_{B}.

When receiving both a plurality of the substantially cylindrical work pieces and the secondary substantially cylindrical work pieces, the refractory article 1 can have a carrying capacity of at least about 1.0 substantially cylindrical and secondary substantially cylindrical work pieces per square inch when viewed from the top surface 102 of the body 100, wherein each one of the plurality of substantially cylindrical work pieces has a cross sectional area, A_{WP}, and wherein A_{WP} is approximately 0.283 square inches. For example, in particular embodiments, the refractory article 1 can have a carrying capacity of at least about 1.1 substantially cylindrical and secondary substantially cylindrical work pieces per square inch when A_{WP} is approximately 0.283 square inches, such as at least about 1.5 substantially cylindrical and secondary substantially cylindrical work pieces per square inch, at least about 2.0 substantially cylindrical and secondary substantially cylindrical work pieces per square inch, at least about 2.5 substantially cylindrical and secondary substantially cylindrical work pieces per square inch, at least about 3.0 substantially cylindrical and secondary substantially cylindrical work pieces per square inch, or even at least about 4.0 substantially cylindrical and secondary substantially cylindrical work pieces per square inch. In more particular embodiments, the refractory article 1 can have a carrying capacity of no greater than about 7 substantially cylindrical and secondary substantially cylindrical work pieces per square inch when A_{WP} is approximately 0.283 square inches, no greater than about 6 substantially cylindrical and secondary substantially cylindrical work pieces per square inch, or no greater than about 5 substantially cylindrical and secondary substantially cylindrical work pieces per square inch.

Each body 100 can further comprise a plurality of auxiliary openings 200 extending into the body 100 from a bottom surface 104 thereof. Each auxiliary opening of the plurality of auxiliary openings 200 can be positioned along the bottom surface 104 of the body 100 in axial alignment with a centerline 122 of the adjacent wall 118.

In certain embodiments, each auxiliary opening 200 can comprise a discrete opening extending into the body 100 from the bottom surface 104 thereof. That is, each auxiliary opening 200 can be shaped and sized to receive a top end 402 of one of the second plurality of substantially cylindrical work pieces 401.

Each auxiliary opening of the plurality of auxiliary openings 200 can comprise any shape. For example, in particular embodiments, the each auxiliary opening 200 can comprise a flat top surface 202 parallel with the bottom surface 104 of the body 100. In other embodiments, each one of the auxiliary openings 200 can be hemispherical (i.e., inwardly rounded). In such embodiments, each auxiliary opening 200 can comprise a point location as measured by a maximum distance the auxiliary opening 200 extends from the bottom surface 104 of the body 100. In yet other embodiments, each auxiliary opening 200 can comprise any shape, such as, for example, a polygonal or ellipsoidal shape positioned at any angle relative to the bottom surface 104 of the body 100.

In other embodiments, each auxiliary opening 200 can comprise an elongated opening (channel) similar to the openings 108. Each one of the auxiliary openings 200 can be aligned parallel with a centerline 122 of the adjacent wall 118 on the top surface 102 of the body 100. In a certain aspect, each one of the auxiliary openings 200 can be adapted to receive the top end 402 of one discrete work piece of the second plurality of substantially cylindrical work pieces 401.

It should be understood that each auxiliary opening 200 can have any number of characteristics or features similar to the openings 108 extending into the body 100 from the top surface 102 thereof.

In particular embodiments, the bottom surface 104 and accompanying auxiliary openings 200 can be rotationally symmetrical with the top surface 102 and accompanying openings. In a particular aspect, the features (openings) of the bottom surface 104 of the body 100 can be arranged such that when the body 100 is rotated 180 degrees (i.e., the bottom surface becomes the top surface) the body 100 maintains the same dimensional characteristics as prior to the rotation. Moreover, the auxiliary openings 200 can be arranged such that after the body 100 is rotated 180 degrees, the auxiliary openings 200 are positioned at the same relative Cartesian coordinates (X, Y) as the openings 108 were prior to rotation of the body 100.

Maintaining the auxiliary openings 200 in the same relative Cartesian coordinate locations as the openings 108, may facilitate reversibility of the refractory article 1, allowing a user to use the refractory article 1 even in the event a portion of one of the surfaces 102, 104 becomes damaged or unusable.

Each auxiliary opening 200 can extend into the body 100 a distance, D_{AUX}, as measured by a maximum distance from the bottom surface 104 of the body 100 to a top surface 202 of the auxiliary openings 200. In certain embodiments, D_{AUX} can be no greater than the difference between the thickness of the body, T_{B}, and the depth of the opening, D_{O}. In other words, in certain embodiments, D_{O}+D_{AUX} can be no greater than T_{B}.

In other embodiments, particularly where the top surface 202 of the auxiliary openings 200 are rounded or hemispherical, D_{AUX} can be slightly greater than the difference between T_{B} and D_{O}. For example, in certain embodiments, D_{AUX} can be no greater than about 1.2(T_{B}−D_{O}), such as no greater than about 1.15(T_{B}−D_{O}), no greater than about 1.1(T_{B}−D_{O}), or even no greater than about 1.05(T_{B}−D_{O}).

In particular embodiments, D_{O} can be greater than D_{AUX}. In more particular embodiments, D_{O}/D_{AUX} can be at least about 1.01, such as at least about 1.05, at least about 1.10, at least about 1.15, at least about 1.20, at least about 1.25, at least about 1.30, at least about 1.35, at least about 1.40, at least about 1.45, at least about 1.50, at least about 1.55, at least about 1.60, at least about 1.65, at least about 1.70, at least about 1.75, at least about 1.80, at least about 1.85, at least about 1.90, at least about 1.95, or even at least about 2.00. In such aspect, D_{O}/D_{AUX} can be no greater than about 5, such as no greater than about 4, no greater than about 3, or even no greater than about 2. Moreover, D_{O}/D_{AUX} can be within a range between and including any of the values described above, such as, for example, between about 1.3 and about 2.1.

In further embodiments, D_{AUX} can be greater than D_{O}. In more particular embodiments, D_{AUX}/D_{O} can be at least about 1.01, such as at least about 1.05, at least about 1.10, at least about 1.15, at least about 1.20, at least about 1.25, at least about 1.30, at least about 1.35, at least about 1.40, at least about 1.45, at least about 1.50, at least about 1.55, at least about 1.60, at least about 1.65, at least about 1.70, at least about 1.75, at least about 1.80, at least about 1.85, at least about 1.90, at least about 1.95, or even at least about 2.00. In such aspect, D_{AUX}/D_{O} can be no greater than about 5, such as no greater than about 4, no greater than about 3, or even no greater than about 2. Moreover, D_{AUX}/D_{O} can be within a range between and including any of the values described above, such as, for example, between about 1.3 and about 2.1.

In particular embodiments, the auxiliary openings 200 can each have a length, L_{AUX} (not shown), extending along the length of the body, L_{B}. In particular embodiments, the length of each one of the auxiliary openings 200 can be measured along a centerline 204 of the auxiliary opening 200. In a particular embodiment, L_{B}/L_{AUX} can be no less than about 0.3, such as no less than about 0.4, no less than about 0.5, no less than about 0.6, no less than about 0.7, no less than about 0.8, no less than about 0.9, no less than about 1.0, no less than about 1.2, or even no less than about 1.4. In particular aspects, L_{B}/L_{AUX} can be no greater than about 10.0, such as no greater than about 5.0, no greater than about 2.0, or even no greater than about 1.5. Moreover, L_{B}/L_{AUX} can be within a range between and including any of the values described above, such as, for example, between about 0.9 and about 1.4.

In particular embodiments, an open volume, V_{AUX}, of each one of the auxiliary openings 200 can be defined by the volume contained within the auxiliary opening 200 above the bottom surface 104 of the body 100. In particular embodiments, V_{B}/V_{AUX} can be no less than about 1.5, such as no less than about 2.0, or even no less than about 2.5. Furthermore, V_{B}/V_{AUX} can be no greater than about 75, such as no greater than about 50, no greater than about 30, no greater than about 10, no greater than about 5, no greater than about 4, or even no greater than about 3. Moreover, V_{B}/V_{AUX} can be within a range between and including any of the values described above, such as, for example, between about 6.0 and about 9.0.

As seen in FIG. 6, the refractory article 1 can further include a spacer 300 engaged between a first body 100 and a second body 101. The spacer 300 can have a length, L_{S}, extending perpendicular to the top and bottom surfaces 102 and 104 of adjacent positioned bodies 100 and 100.

In particular embodiments, L_{S} can be approximately equal to D₁. In such embodiments, a top end of each substantially cylindrical work piece of the plurality of substantially cylindrical work pieces 400 can contact the bottom surface 102 of the upper body 101. Additionally, in further embodiments, a top end 401 of each one of the second plurality of substantially cylindrical work pieces 402 can contact the top surface 202 of an auxiliary opening 200.

In other embodiments, L_{S} can be greater than D₁. For example, L_{S} can be at least about 1.01 D₁, such as at least about 1.02 D₁, at least about 1.05 D₁, at least about 1.1 D₁, or even at least about 1.2 D₁. Moreover, in certain embodiments, L_{S} can be no greater than about 2 D₁, such as no greater than about 1.9 D₁, no greater than about 1.8 D₁, no greater than about 1.7 D₁, no greater than about 1.6 D₁, or even no greater than about 1.5 D₁.

The spacer 300 can be formed from a refractory material, such as, for example, a ceramic material. Moreover, the spacer 300 can be formed from a single monolithic construction or can comprise several segments. The spacer 300 can have any shape, such as for example, a substantially cylindrical cross-sectional shape having a central axis extending perpendicular to the top and bottom surfaces 101 and 104 of the bodies 100 and 100. The spacer 300 can have one or more internal cavities (i.e., hollow) or can be devoid of any internal cavities.

In particular embodiments, the spacer 300 can have axial extensions 302 that extend from the spacer 300 and correspond with spacer slots 106 located in the bodies 100 and 100. The combination of the spacer extensions 302 and the spacer slots 106 may increase stability during stacking and transportation of the refractory articles 1 both prior to and after receiving the work pieces.

It should be understood that in yet further embodiments, several bodies 100 can be stacked to form several vertical layers. For example, a three level assembly can be formed by aligning three bodies and two sets of spacers (alternating the spacers between the bodies). Similarly, a four level assembly can be formed by aligning four bodies and three sets of spacers.

In particular embodiments, as the number of bodies increases (i.e., the number of levels increases), it may become necessary to add additional spacers between adjacent bodies to prevent sagging. In a particular embodiment, such as illustrated in FIG. 7, three spacer slots 106 can be disposed along the body 100. The spacer slots 106 may have a triangular arrangement. More particularly, the spacer slots 106 may have a non-right angled triangular arrangement. This may reduce rocking between levels of an assembly and increase stability therebetween. The illustrated spacer slot layout is merely exemplary of the various embodiments described herein, but has been found to facilitate increased carrying capacity of the body 100 while minimizing sagging and bowing therealong.

In an embodiment, the spacer slots 106 and 106 adjacent to the major side surface 140 may be disposed within serrations created by the opening 108 nearest to the major side surface 140. The spacer slot 106 adjacent to the major side surface 134 may similarly be disposed within a serration created by the opening 108 nearest to the major side surface 134.

Use of a body shape such as illustrated in FIG. 7 permits a spacer slot 106 to be disposed near major side surface 134 without interfering with the openings 108, while simultaneously providing equal sidewall thickness to all openings 108. In an embodiment, the major side surfaces 136 and 144 may extend in, or substantially in, parallel with segments of the opening 108. The distance between the major side surfaces 136 and 144 and the segments may be equal to the distance between two adjacent openings 108. In a particular embodiment, the spacer slot 106 disposed near the major side surface 134 may be centrally disposed between segments of the opening 108 nearest the major side surface 134 and major side surfaces 134, 136, and 144. In such a manner, forces transmitted by a spacer (not illustrated) to the body 100 can be more evenly distributed, thus increasing overall strength of the body 100.

The embodiments herein are directed to a refractory article that can provide a high carrying capacity for generally cylindrical work pieces to be fired while maintaining structural rigidity and integrity. The refractory article herein can utilize a body having an opening configured to receive a plurality of substantially cylindrical work pieces and individually support each one of the substantially cylindrical work pieces. Notably, in particular embodiments, the present refractory article can utilize a plurality of discrete containment regions positioned within the opening, each of the discrete containment regions in open communication with adjacent discrete containment regions.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. A refractory setter plate comprising:
a body; and
an opening extending into the body, wherein the opening is configured to receive a plurality of substantially cylindrical work pieces and configured to individually support each one of the substantially cylindrical work pieces of the plurality of substantially cylindrical work pieces.

Item 2. A refractory setter plate comprising:
a body;
an opening extending into the body, the opening configured to receive a plurality of substantially cylindrical work pieces, the opening having a sidewall defining a plurality of discrete containment regions, each discrete containment region of the plurality of discrete containment regions configured to support a substantially cylindrical work piece from the plurality of substantially cylindrical work pieces.

Item 3. A refractory setter plate comprising:
a body comprising a refractory material; and
an opening extending into the body, the opening configured to support a plurality of substantially cylindrical work pieces, the opening having an undulating sidewall profile defining a plurality of discrete containment regions, each discrete containment region of the plurality of discrete containment regions configured to support at least a portion of a single substantially cylindrical work piece of the plurality of substantially cylindrical work pieces; and
wherein each discrete containment region of the plurality of discrete containment regions defines an arc length having a length, L_{A}, wherein each discrete containment region of the plurality of discrete containment regions defines a length, L_{DCR}, and wherein L_{A}/L_{DCR} is no less than about 0.005.

Item 4. The refractory setter plate according to any one of items 1 or 2, wherein the body comprises a refractory material.

Item 5. The refractory setter plate according to any one of the preceding items, wherein the body comprises a ceramic material.

Item 6. The refractory setter plate according to any one of the preceding items, wherein the body comprises Alumina, Silica, Zirconia, Spinel, or a combination thereof.

Item 7. The refractory setter plate according to any one of the preceding items, wherein the body comprises nitrogen-bonded silicon carbide, wherein the body consists essentially of nitrogen-bonded silicon carbide.

Item 8. The refractory setter plate according to any one of the preceding items, wherein the body comprises a material having a porosity of no greater than about 60 vol % for a total volume of the body, no greater than about 10 vol %, no greater than about 5 vol %, no greater than about 4 vol %, no greater than about 3 vol %, no greater than about 2 vol %, no greater than about 1 vol %, no greater than about 0.5 vol %, no greater than about 0.1 vol %.

Item 9. The refractory setter plate according to any one of the preceding items, wherein the body comprises a material having a Modulus of Elasticity at 20° C. of no less than about 5 gigapascals (GPa), no less than about 20 GPa, no less than about 50 GPa, no less than about 75 GPa, no less than about 90 GPa, no less than about 100 GPa, no less than about 110 GPa, no less than about 120 GPa, no less than about 130 GPa, no less than about 140 GPa, no less than about 150 GPa, no less than about 175 GPa, no less than about 200 GPa, no less than about 250 GPa, no less than about 300 GPa, no less than about 350 GPa.

Item 10. The refractory setter plate according to any one of the preceding items, wherein the body comprises a material having a Modulus of Elasticity at 20° C. of no greater than about 500 GPa, no greater than about 450 GPa, no greater than about 400 GPa.

Item 11. The refractory setter plate according to any one of the preceding items, wherein the body comprises a material having a Modulus of Rupture at 1250° C. of no less than about 1.5 megapascals (MPa), no less than about 10 MPa, no less than about 25 MPa, no less than about 50 MPa, no less than about 75 MPa, no less than about 100 MPa, no less than about 150 MPa, no less than about 200 MPa, no less than about 250 MPa, no less than about 300 MPa, no less than about 350 MPa.

Item 12. The refractory setter plate according to any one of the preceding items, wherein the body comprises a material having a Modulus of Rupture at 1250° C. of no greater than about 500 MPa, no greater than about 450 MPa, no greater than about 400 MPa.

Item 13. The refractory setter plate according to any one of the preceding items, wherein the body comprises a material having a coefficient of thermal expansion (CTE) of no greater than about 9.0×10⁻⁶a·° C.⁻¹, no greater than about 8.5×10⁻⁶a·° C.⁻¹, no greater than about 8.0×10⁻⁶a·° C.⁻¹, no greater than about 7.5×10⁻⁶a·° C.⁻¹, no greater than about 7.0×10⁻⁶a·° C.⁻¹, no greater than about 6.5×10⁻⁶a·° C.⁻¹, no greater than about 6.0×10⁻⁶a·° C.⁻¹, no greater than about 5.5×10⁻⁶a·° C.⁻¹, no greater than about 5.0×10⁻⁶a·° C.⁻¹, no greater than about 4.5×10⁻⁶a·° C.⁻¹.

Item 14. The refractory setter plate according to any one of the preceding items, wherein the body comprises a material having a coefficient of thermal expansion (CTE) of no less than about 1.0×10⁻⁶a·° C.⁻¹, no less than about 2.0×10⁻⁶a·° C.⁻¹, no less than about 3.0×10⁻⁶a·° C.⁻¹, no less than about 3.5×10⁻⁶a·° C.⁻¹, no less than about 4.0×10⁻⁶a·° C.⁻¹.

Item 15. The refractory setter plate according to any one of the preceding items, wherein the body comprises a material having a thermal conductivity at 1200° C. of no less than about 0.5 W/mK, no less than about 5 W/mK, no less than about 10 W/mK, no less than about 15 W/mK, no less than about 20 W/mK, no less than about 25 W/mK, no less than about 30 W/mK, no less than about 40 W/mK.

Item 16. The refractory setter plate according to any one of the preceding items, wherein the body comprises a material having a thermal conductivity at 1200° C. of no greater than about 100 W/mK, no greater than about 90 W/mK, no greater than about 80 W/mK, no greater than about 70 W/mK, no greater than about 60 W/mK, no greater than about 50 W/mK.

Item 17. The refractory setter plate according to any one of the preceding claims, wherein the opening has a length, L_{O}, and an average width, W_{O}, and wherein L_{O} is greater than W_{O}.

Item 18. The refractory setter plate according to item 17, wherein L_{O}/W_{O} is greater than about 1.5, greater than about 2.0, greater than about 2.5, greater than about 3.0, greater than about 3.5, greater than about 4.0, greater than about 4.5, greater than about 5.0, greater than about 10.0, greater than about 15.0, greater than about 20.0, greater than about 25.0, greater than about 30.0, greater than about 35.0, greater than about 40.0, greater than about 45.0, greater than about 50.0.

Item 19. The refractory setter plate according to any one of items 17 or 18, wherein L_{O}/W_{O} is no greater than about 200, no greater than about 175, no greater than about 150, no greater than about 125, no greater than about 100, no greater than about 75.

Item 20. The refractory setter plate according to any one of the preceding items, wherein the body has a thickness, T_{B}, measured as a distance between the top surface and a bottom surface, wherein the opening comprises a depth, D_{O}, measured as a distance the opening extends into the body between a top surface of the body and a bottom surface of the opening, and wherein T_{B} is equal to or greater than D_{O}.

Item 21. The refractory setter plate according to item 20, wherein T_{B}/D_{O} is at least about 1.01, at least about 1.05, at least about 1.10, at least about 1.15, at least about 1.20, at least about 1.25, at least about 1.30, at least about 1.35, at least about 1.40, at least about 1.45, at least about 1.50, at least about 1.55, at least about 1.60, at least about 1.65, at least about 1.70, at least about 1.75, at least about 1.80, at least about 1.85, at least about 1.90, at least about 1.95, at least about 2.00.

Item 22. The refractory setter plate according to any one of items 20 or 21, wherein T_{B}/D_{O} is no greater than about 5, no greater than about 4, no greater than about 3, no greater than about 2.

Item 23. The refractory setter plate according to any one of items 17-22, wherein the body has a length, L_{B}, as measured between two opposite sides of the body, and wherein L_{B}/L_{O} is no less than about 0.3, no less than about 0.4, no less than about 0.5, no less than about 0.6, no less than about 0.7, no less than about 0.8, no less than about 0.9, no less than about 1.0, no less than about 1.2, no less than about 1.4.

Item 24. The refractory setter plate according to item 23, wherein L_{B}/L_{O} is no greater than about 10.0, no greater than about 5.0, no greater than about 2.0, no greater than about 1.5.

Item 25. The refractory setter plate according to any one of items 17-24, wherein the body has a width, W_{B}, as measured between two opposite sides of the body, and wherein W_{B}/W_{O} is no less than about 1.0, no less than about 2.0, no less than about 5.0, no less than about 10.0, no less than about 20.0, no less than about 30.0, no less than about 40.0.

Item 26. The refractory setter plate according to item 25, wherein W_{B}/W_{O} is no greater than about 100, no greater than about 90, no greater than about 80, no greater than about 70, no greater than about 60, no greater than about 50, no greater than about 40.

Item 27. The refractory setter plate according to any one of the preceding items, wherein the opening is configured to receive no less than 2 substantially cylindrical work pieces, no less than 5 substantially cylindrical work pieces, no less than 10 substantially cylindrical work pieces, no less than 15 substantially cylindrical work pieces, no less than 20 substantially cylindrical work pieces, no less than 25 substantially cylindrical work pieces, no less than 30 substantially cylindrical work pieces, no less than 40 substantially cylindrical work pieces, no less than 50 substantially cylindrical work pieces.

Item 28. The refractory setter plate according to any one of the preceding items, wherein the body comprises a volume, V_{B}, wherein the opening comprises an open volume, V_{O}, and wherein V_{B}/V_{O} is no less than about 1.5, no less than about 2.0, no less than about 2.5.

Item 29. The refractory setter plate according to item 28, wherein V_{B}/V_{O} is no greater than about 75, no greater than about 50, no greater than about 30, no greater than about 10, no greater than about 5, no greater than about 4, no greater than about 3.

Item 30. The refractory setter plate according to any one of the preceding items, wherein the opening is configured to receive no greater than 1000 substantially cylindrical work pieces, no greater than 500 substantially cylindrical work pieces, no greater than 400 substantially cylindrical work pieces, no greater than 300 substantially cylindrical work pieces, no greater than 200 substantially cylindrical work pieces, no greater than 100 substantially cylindrical work pieces.

Item 31. The refractory setter plate according to any one of the preceding items, wherein the opening forms a substantially serrated shape as viewed from a top surface of the body.

Item 32. The refractory setter plate according to any one of the preceding items, wherein the opening comprises a plurality of segments, and wherein two adjacent segments of the plurality of segments, when viewed a top surface of the body, form a relative angle, A, therebetween of less than about 180 degrees, less than about 170 degrees, less than about 160 degrees, less than about 150 degrees, less than about 140 degrees, less than about 130 degrees, less than about 120 degrees, less than about 110 degrees, less than about 100 degrees, less than about 90 degrees, less than about 80 degrees, less than about 70 degrees, less than about 60 degrees, less than about 50 degrees, less than about 40 degrees, less than about 30 degrees, less than about 20 degrees, less than about 10 degrees.

Item 33. The refractory setter plate according to item 32, wherein A is greater than about 0 degrees, greater than about 1 degree, greater than about 2 degrees, greater than about 3 degrees, greater than about 4 degrees, greater than about 5 degrees, greater than about 6 degrees, greater than about 7 degrees, greater than about 8 degrees, greater than about 9 degrees.

Item 34. The refractory setter plate according to any one of the preceding items, wherein the opening comprises at least 2 segments, at least 3 segments, at least 4 segments, at least 5 segments, at least 6 segments, at least 7 segments, at least 8 segments, at least 9 segments, at least 10 segments.

Item 35. The refractory setter plate according to any one of items 32-34, wherein the opening comprises no more than 200 segments, no more than 100 segments, no more than 75 segments, no more than 50 segments, no more than 25 segments.

Item 36. The refractory setter plate according to any one of the preceding items, wherein the opening comprises a plurality of openings.

Item 37. The refractory setter plate according to item 36, wherein the plurality of openings comprise at least 2 openings, at least 3 openings, at least 4 openings, at least 5 openings, at least 10 openings, at least 15 openings, at least 20 openings, at least 25 openings, at least 30 openings, at least 35 openings, at least 40 openings, at least 45 openings, at least 50 openings.

Item 38. The refractory setter plate according to any one of items 36 or 37, wherein the plurality of openings comprise no more than 100 openings, no more than 90 openings, no more than 80 openings, no more than 70 openings, no more than 60 openings.

Item 39. The refractory setter plate according to any one of items 36-38, wherein each of the openings of the plurality of openings are substantially parallel with each other when viewed from the top surface

Item 40. The refractory setter plate according to any one of items 33-39, wherein the body comprises an average wall thickness, T_{W}, extending between adjacent openings of the plurality of openings, wherein the each opening of the plurality of openings has a maximum width, W_{MO}, and wherein T_{W}/W_{MO} is at least about 0.5, at least about 0.6, at least about 0.7, at least about 0.8, at least about 0.9, at least about 1.0.

Item 41. The refractory setter plate according to item 40, wherein T_{W}/W_{MO} is no greater than about 4.0, no greater than about 3.0, no greater than about 2.0, no greater than about 1.5.

Item 42. The refractory setter plate according to any one of the preceding items, wherein each discrete containment region of the plurality of discrete containment regions comprises a central axis angled substantially perpendicular to a top surface of the body, wherein each substantially cylindrical work pieces has a central axis, and wherein each discrete containment region of the plurality of discrete containment regions is adapted to receive a substantially cylindrical work piece substantially coaxial therewith.

Item 43. The refractory setter plate according to item 42, wherein the central axis of the plurality of substantially cylindrical work pieces are substantially parallel with one another.

Item 44. The refractory setter plate according to item 1, wherein the opening comprises a structure configured to maintain each substantially cylindrical work piece of the plurality of substantially cylindrical work pieces in a substantially constant orientation.

Item 45. The refractory setter plate according to item 44, wherein the structure is defined by a projection.

Item 46. The refractory setter plate according to any one of items 44 or 45, wherein the structure extends from the body into the opening.

Item 47. The refractory setter plate according to any one of items 44-46, wherein the structure extends from a sidewall of the opening into the opening.

Item 48. The refractory setter plate according to any one of items 44-47, wherein the opening has a maximum width, W_{MO}, wherein the structure has a maximum width, W_{MS}, as measured perpendicular to a sidewall of the opening, and wherein W_{MS} is no less than about 0.01 W_{MO}, no less than about 0.05 W_{MO}, no less than about 0.10 W_{MO}, no less than about 0.15 W_{MO}, no less than about 0.20 W_{MO}, no less than about 0.25 W_{MO}, no less than about 0.30 W_{MO}, no less than about 0.35 W_{MO}, no less than about 0.40 W_{MO}, no less than about 0.45 W_{MO}, no less than about 0.50 W_{MO}.

Item 49. The refractory setter plate according to item 48, wherein W_{MS} is less than about 1.0 W_{MO}, less than about 0.95 W_{MO}, less than about 0.90 W_{MO}, less than about 0.85 W_{MO}, less than about 0.80 W_{MO}, less than about 0.75 W_{MO}, less than about 0.70 W_{MO}, less than about 0.65 W_{MO}, less than about 0.60 W_{MO}, less than about 0.55 W_{MO}, less than about 0.50 W_{MO}, less than about 0.45 W_{MO}.

Item 50. The refractory setter plate according to any one of items 44-49, wherein the opening has a depth, D_{O}, measured as a distance the opening extends into the body between a top surface of the body and a bottom surface of the opening, and wherein the structure has a depth, D_{S}, as measured in an orientation parallel with D_{O}, and wherein D_{S} is no less than about 0.1 D_{O}, no less than about 0.2 D_{O}, no less than about 0.3 D_{O}, no less than about 0.4 D_{O}, no less than about 0.5 D_{O}, no less than about 0.6 D_{O}, no less than about 0.7 D_{O}, no less than about 0.8 D_{O}, no less than about 0.9 D_{O}.

Item 51. The refractory setter plate according to item 50, wherein D_{O} is no greater than D_{S}.

Item 52. The refractory setter plate according to any one of items 50 or 51, wherein D_{O} is equal to D_{S}.

Item 53. The refractory setter plate according to any one of items 44-52, wherein the structure is generally polygonal as viewed from a top surface of the body.

Item 54. The refractory setter plate according to any one of items 44-53, wherein the structure is generally triangular as viewed from a top surface of the body.

Item 55. The refractory setter plate according to any one of items 44-52, wherein the structure is generally ellipsoidal as viewed from a top surface of the body.

Item 56. The refractory setter plate according to any one of items 44-55, wherein the structure further comprises a plurality of structures, each structure of the plurality of structures spaced apart within the opening.

Item 57. The refractory setter plate according to item 56, wherein the plurality of structures are equally spaced apart when viewed from a top surface of the body.

Item 58. The refractory setter plate according to any one of items 56 or 57, wherein at least one structure of the plurality of structures defines a discrete containment region within the opening, the discrete containment region configured to support one substantially cylindrical work piece therein.

Item 59. The refractory setter plate according to any one of items 56-58, wherein a discrete containment region is defined by at least 2 structures of the plurality of structures, at least 3 structures of the plurality of structures, at least 4 structures.

Item 60. The refractory setter plate according to any one of items 56-59, wherein a discrete containment region is defined by no greater than 5 structures.

Item 61. The refractory setter plate according to any one of the preceding items, wherein the opening is adapted to receive a first end of each substantially cylindrical work piece of the plurality of substantially cylindrical work pieces.

Item 62. The refractory setter plate according to any one of the preceding items, wherein the opening comprises at least 2 discrete containment regions, at least 5 discrete containment regions, at least 10 discrete containment regions, at least 15 discrete containment regions, at least 20 discrete containment regions, at least 30 discrete containment regions, at least 40 discrete containment regions, at least 50 discrete containment regions, at least 75 discrete containment regions, at least 100 discrete containment regions, at least 150 discrete containment regions, at least 200 discrete containment regions.

Item 63. The refractory setter plate according to any one of the preceding items, wherein the opening comprises no more than 500 discrete containment regions, no more than 400 discrete containment regions, no more than 300 discrete containment regions, no more than 200 discrete containment regions.

Item 64. The refractory setter plate according to any one of items 2-63, wherein each discrete containment region is in open communication with an adjacent discrete containment region.

Item 65. The refractory setter plate according to any one of items 2-64, wherein each discrete containment region comprises a volume, V_{R}, wherein each one of the plurality of substantially cylindrical work pieces comprises a volume, V_{WP}, and wherein V_{R}/V_{WP} is no less than about 1.0, no less than about 1.05, no less than about 1.1, no less than about 1.15, no less than about 1.2, no less than about 1.25, no less than about 1.3, no less than about 1.35, no less than about 1.4.

Item 66. The refractory setter plate according to item 65, wherein V_{R}/V_{WP} is no greater than about 2.0, no greater than about 1.9, no greater than about 1.8, no greater than about 1.7, no greater than about 1.6, no greater than about 1.5, no greater than about 1.4.

Item 67. The refractory setter plate according to any one of items 1, 2, or 4-52, wherein the opening defines an undulated sidewall profile defining a plurality of discrete containment regions.

Item 68. The refractory setter plate according to item 67, wherein the undulated sidewall profile defines a discrete containment region arc length associated with each of the single discrete containment regions of the plurality of discrete containment regions, the discrete containment region arc length having a length, L_{A}, wherein L_{A} is within a range between about 0.1 inches and about 12.0 inches.

Item 69. The refractory setter plate according to item 68, wherein L_{A} is within a range between about 0.25 inches and about 1.0 inch.

Item 70. The refractory setter plate according to any one of items 68 or 69, wherein L_{A} is within a range between about 0.4 inches and about 0.6 inches.

Item 71. The refractory setter plate according any one of items 68-70, wherein each substantially cylindrical work piece of the plurality of substantially cylindrical work pieces contacts the undulated sidewall profile along a contact length, L_{C}, and wherein L_{A}/L_{C} is no less than about 1.0, no less than about 1.1, no less than about 1.2, no less than about 1.3, no less than about 1.4, no less than about 1.5, no less than about 1.6.

Item 72. The refractory setter plate according to item 71, wherein L_{A}/L_{C} is no greater than 2.5, no greater than 2.0, no greater than 1.9, no greater than 1.8, no greater than 1.7, no greater than 1.6.

Item 73. The refractory setter plate according to any one of the preceding items, wherein each one of the plurality of substantially cylindrical work pieces has a cross sectional area, A_{WP}, wherein A_{WP} is no less than approximately 0.2 square inches, and wherein the refractory setter plate has a carrying capacity of no less than about 1.1 substantially cylindrical work pieces per square inch, at least about 1.2 substantially cylindrical work pieces per square inch, at least about 1.3 substantially cylindrical work pieces per square inch, at least about 1.4 substantially cylindrical work pieces per square inch, at least about 1.5 substantially cylindrical work pieces per square inch, at least about 1.6 substantially cylindrical work pieces per square inch, at least about 1.7 substantially cylindrical work pieces per square inch, at least about 1.8 substantially cylindrical work pieces per square inch, at least about 1.9 substantially cylindrical work pieces per square inch, at least about 2.0 substantially cylindrical work pieces per square inch, at least about 2.1 substantially cylindrical work pieces per square inch, at least about 2.2 substantially cylindrical work pieces per square inch, at least about 2.3 substantially cylindrical work pieces per square inch, at least about 2.4 substantially cylindrical work pieces per square inch.

Item 74. The refractory setter plate according to any one of the preceding items, wherein the refractory setter plate has a carrying capacity of no greater than about 5 substantially cylindrical work pieces per square inch, no greater than about 4 substantially cylindrical work pieces per square inch, no greater than about 3 substantially cylindrical work pieces per square inch.

Item 75. The refractory setter plate according to any one of items 2-43 or 58-74, wherein each discrete containment region of the plurality of discrete containment regions defines a volume, V_{DCR}, wherein the opening defines a volume, V_{O}, and wherein V_{O}/V_{DCR} is no less than about 2, no less than about 3, no less than about 4, no less than about 5, no less than about 6, no less than about 7, no less than about 8, no less than about 9, no less than about 10, no less than about 15, no less than about 20, no less than about 25, no less than about 30, or no less than about 50.

Item 76. The refractory setter plate according to item 75, wherein V_{O}/V_{DCR} is no greater than about 500, no greater than about 400, no greater than about 300, or no greater than about 200.

Item 77. The refractory setter plate according to any one of the preceding items, wherein the body is configured to receive a second plurality of substantially cylindrical work pieces.

Item 78. The refractory setter plate according to item 77, wherein the body is configured to receive a second plurality of substantially cylindrical work pieces along a wall located between a first opening and a second opening.

Item 79. The refractory setter plate according to any one of items 77 or 78, wherein the wall has a top surface substantially coplanar with a top surface of the body.

Item 80. The refractory setter plate according to item 79, wherein the top surface of the wall is coplanar with the top surface of the body.

Item 81. The refractory setter plate according to any one of items 78-80, wherein each wall is configured to support a number, N_{W}, of substantially cylindrical work pieces of the second plurality of substantially cylindrical work pieces, wherein each opening is configured to support a number, N_{O}, of substantially cylindrical work pieces of the second plurality of substantially cylindrical work pieces, and wherein N_{W} is between about 0.1/V_{O} and about 1.5/V_{O}.

Item 82. The refractory setter plate according to item 81, wherein N_{O} is between about 0.7/V_{O} and about 1.2/V_{O}.

Item 83. The refractory setter plate according to any one of items 80 or 81, wherein N_{O} is between about 0.9/V_{O} and about 1.0/V_{O}.

Item 84. The refractory setter plate according to any one of the preceding items, wherein the body further comprises:
a bottom surface; and
a plurality of auxiliary openings extending from the bottom surface into the body substantially perpendicular to the bottom surface.

Item 85. The refractory setter plate according to item 84, wherein each auxiliary opening of the plurality of auxiliary openings is configured to receive a second end of a single substantially cylindrical work piece of the second plurality of substantially cylindrical work pieces.

Item 86. The refractory setter plate according to any one of items 84 or 85, further comprising:
a first body, wherein the first body is configured to receive and support a first end of a first plurality of substantially cylindrical work pieces within the opening, the first plurality of substantially cylindrical work pieces extending beyond the top surface of the first body a distance, D₁, wherein the first body is configured to receive a first end of a second plurality of substantially cylindrical work pieces on a wall adjacent to the opening, the second plurality of substantially cylindrical work pieces extending beyond the top surface of the first body a distance, D₂, wherein D₂ is greater than D₁; and
a second body, the second body having substantially the same dimensional characteristics as the first body, a bottom surface of the second body configured to be substantially parallel with the top surface of the first body, wherein the bottom surface of the second body is a distance, D_{B}, away from the top surface of the first body, wherein each auxiliary opening of the plurality of auxiliary openings is configured to receive a second end of the second plurality of substantially cylindrical work pieces, the second end of the second plurality of substantially cylindrical work pieces extending into the second body a distance as defined by the difference between D₂ and D_{B}.

Item 87. The refractory setter plate according to any one of items 84-86, wherein each auxiliary opening of the plurality of auxiliary openings is substantially hemispherical.

Item 88. The refractory setter plate according to any one of items 89 or 87, further comprising a spacer, the spacer configured to space apart the first body from the second body in a direction substantially perpendicular to the top surface of the first body.

Item 89. The refractory setter plate according to item 88, wherein the spacer has a length that is approximately equal to D_{B}.

Item 90. A refractory setter plate comprising:
a body having a top surface and a bottom surface spaced apart by a thickness, T_{B};
a plurality of openings extending into the body from the top surface, wherein:
   each opening of the plurality of openings is configured to receive a plurality of workpieces and individually support each one of the workpieces of the plurality of workpieces,
   at least two of the openings are adapted to receive a same number of workpieces, and
   at least two of the openings comprise a same number of segments;
a plurality of auxiliary openings extending into the body from the bottom surface, wherein:
   each auxiliary opening of the plurality of auxiliary openings is configured to receive at least one workpiece and individually support the at least one workpiece, and
   at least two of the auxiliary openings are adapted to receive a same number of workpieces; and
a plurality of spacer slots extending at least partially through the thickness of the body, each spacer slot adapted to receive at least a portion of a spacer.

Item 91. A refractory setter plate comprising:
a body having a top surface and a bottom surface spaced apart by a thickness, T_{B};
a plurality of openings extending into the body from the top surface, wherein:
   each opening of the plurality of openings is configured to receive a plurality of workpieces and individually support each one of the workpieces of the plurality of workpieces;
a plurality of auxiliary openings extending into the body from the bottom surface, wherein:
   each auxiliary opening of the plurality of auxiliary openings is configured to receive a plurality of workpieces and individually support each one of the workpieces of the plurality of workpieces; and
a plurality of spacer slots extending at least partially through the thickness of the body, each spacer slot adapted to receive at least a portion of a spacer,
wherein the refractory setter plate is rotationally symmetrical.

The embodiments provide a combination of features, which can be combined in various matters to describe and define a method and system of the embodiments. The description is not intended to set forth a hierarchy of features, but different features that can be combined in one or more manners to define the invention. In the foregoing, reference to specific embodiments and the connection of certain components is illustrative. It will be appreciated that reference to components as being coupled or connected is intended to disclose either direct connected between said components or indirect connection through one or more intervening components as will be appreciated to carry out the methods as discussed herein.

As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The disclosure is submitted with the understanding that it will not be used to interpret or limit the scope or meaning of the claims. In addition, in the foregoing disclosure, various features may be grouped together or described in a single embodiment for the purpose of streamlining the disclosure. This disclosure is not to be interpreted as reflecting an intention that the embodiments herein limit the features provided in the claims, and moreover, any of the features described herein can be combined together to describe the inventive subject matter. Still, inventive subject matter may be directed to less than all features of any of the disclosed embodiments.

What is claimed is:

1. A refractory setter plate comprising:
a body; and
an opening extending into the body, wherein the opening is configured to receive a plurality of substantially cylindrical work pieces and configured to individually support each one of the substantially cylindrical work pieces of the plurality of substantially cylindrical work pieces.

2. The refractory setter plate according to claim 1, wherein the opening forms a substantially serrated shape as viewed from a top surface of the body.

3. The refractory setter plate according to claim 1, wherein the opening comprises a plurality of openings.

4. The refractory setter plate according to claim 3, wherein all of the openings of the plurality of openings are substantially parallel with each other when viewed from a top surface of the body.

5. The refractory setter plate according to claim 1, wherein the refractory setter plate is rotationally symmetrical.

6. A refractory setter plate comprising:
a body;
an opening extending into the body, the opening configured to receive a plurality of substantially cylindrical work pieces, the opening having a sidewall defining a plurality of discrete containment regions, each discrete containment region of the plurality of discrete containment regions configured to support a substantially cylindrical work piece from the plurality of substantially cylindrical work pieces.

7. The refractory setter plate according to claim 6, wherein the opening comprises a plurality of openings.

8. The refractory setter plate according to claim 7, wherein all of the openings of the plurality of openings are substantially parallel with each other when viewed from the top surface.

9. The refractory setter plate according to claim 6, wherein each discrete containment region is in open communication with an adjacent discrete containment region.

10. The refractory setter plate according to claim 6, wherein the body further comprises:
a bottom surface; and
a plurality of auxiliary openings extending from the bottom surface into the body substantially perpendicular to the bottom surface.

11. The refractory setter plate according to claim 10, wherein at least one of the auxiliary openings of the plurality of auxiliary openings is substantially hemispherical.

12. The refractory setter plate according to claim 6, further comprising:
a second body having a plurality of auxiliary openings extending into the body from a bottom surface thereof,
wherein the body is configured to receive and support a first end of a first plurality of substantially cylindrical work pieces within the opening, the first plurality of substantially cylindrical work pieces extending beyond a top surface of the body a distance, D₁, wherein the body is configured to receive a first end of a second plurality of substantially cylindrical work pieces on a wall adjacent to the opening, the second plurality of substantially cylindrical work pieces extending beyond the top surface of the body a distance, D₂, wherein D₂ is greater than D₁,
wherein a bottom surface of the second body is configured to be substantially parallel with the top surface of the body, wherein the bottom surface of the second body is a distance, D_{B}, away from the top surface of the body, wherein each auxiliary opening of the plurality of auxiliary openings is configured to receive a second end of the second plurality of substantially cylindrical work pieces, the second end of the second plurality of substantially cylindrical work pieces extending into the second body a distance as defined by the difference between D₂ and D_{B}.

13. The refractory setter plate according to claim 12, further comprising a spacer configured to space apart the body from the second body.

14. The refractory setter plate according to claim 13, wherein the spacer has a length that is approximately equal to D_{B}.

15. A refractory setter plate comprising:
a body having a top surface and a bottom surface spaced apart by a thickness, T_{B};
a plurality of openings extending into the body from the top surface, wherein:
each opening of the plurality of openings is configured to receive a plurality of work pieces and individually support each one of the work pieces of the plurality of work pieces,
at least two of the openings are adapted to receive a same number of work pieces, and
at least two of the openings comprise a same number of segments;
a plurality of auxiliary openings extending into the body from the bottom surface, wherein:
each auxiliary opening of the plurality of auxiliary openings is configured to receive at least one work piece and individually support the at least one work piece, and
at least two of the auxiliary openings are adapted to receive a same number of work pieces; and
a plurality of spacer slots extending at least partially through the thickness of the body, each spacer slot adapted to receive at least a portion of a spacer.

16. The refractory setter plate according to claim 15, wherein the refractory setter plate is rotationally symmetrical.

17. The refractory setter plate according to claim 15, wherein all of the openings of the plurality of openings are substantially parallel with each other when viewed from the top surface.

18. The refractory setter plate according to claim 15, wherein at least one of the auxiliary openings of the plurality of auxiliary openings is substantially hemispherical.

19. The refractory setter plate according to claim 15, wherein each opening defines a plurality of discrete containment regions, each discrete containment region adapted to receive one work piece of the plurality of work pieces.

20. The refractory setter plate according to claim 19, wherein each discrete containment region is in open communication with an adjacent discrete containment region.
